(19) United States
(12) Patent Application Publication
(10) Pub. No.: US 2015/0027095 A1
(43) Pub. Date: Jan. 29, 2015

(54) SCREEN PANEL FOR COVERING AT LEAST PARTLY AN AIR INTAKE OPENING OF AN AIR INLET HOUSE OF A COMBUSTION ENGINE OR A COMPRESSOR

(71) Applicant: Global Power Netherlands B.V., Heerlen (NL)

(72) Inventors: Werner Karl Hans Marschall, Bremen (DE); Frank Willems, Stolberg (DE)

(21) Appl. No.: 14/384,924

(22) PCT Filed: Mar. 12, 2013
(86) PCT No.: PCT/NL2013/050160

§ 371 Date: Sep. 12, 2014

(30) Foreign Application Priority Data
Mar. 15, 2012 (NL) 2008494

(51) Int. Cl. F02M 35/024; B01D 46/10

(52) U.S. Cl. CPC F02M 35/02466; F02M 35/02491; B01D 46/10
USPC 55/511

(57) ABSTRACT

The invention relates to a screen panel (7) for covering an air intake opening (5) of an air inlet house (1) of a combustion engine, which air inlet house (1) has at least one filter for filtering the air to be supplied to the combustion engine, wherein the screen panel (7) comprises at least a frame (13) to be connected to the air inlet house (1) of the combustion engine, and at least a metal grid (11) to be connected with the frame (13) for at least partly covering the air intake opening (5) of the air inlet house (1).

The invention relates to a screen panel according to the preamble of claim 1.

In the prior art bird screen or insect screen panels are known to be used in combination with frames to cover air intake openings of an air inlet house comprising filters for filtering the air to be provided to a combustion engine or a compressor. Such a combustion engine is preferably a high performance combustion turbine, which requires filtered, clean and if possible temperature conditioned and compressed air for achieving a high efficiency combustion for generating for example electrical power and useful heat (Combined Heat and Power, CHP). By means of such a screen panel it is prevented that materials such as birds, feathers, insects, parts of plants, etcetera are sucked into the air inlet house. These materials affect the operation of the filters for cleaning to air to be fed to the engine in the air inlet house adversely.

A problem of the known screen panels is that the grids are difficult to be installed and/or removed from the frame during e.g. replacement. In addition, the sharp edges of the metal grid, may injure operators during installation and/or removal of a screen panel.

It is therefore an object of the present invention to provide a screen panel that can be installed in a quick, safe and efficient manner.

This object is achieved by means of a screen panel as is specified in claim 1, more in particular with the features mentioned in the characterizing part of claim 1.

By embedding at least a part of a circumferential edge of the metal grid in an elastic layer, it is possible for an operator without the risk of getting injured, to clamp the elastic layer into the frame for connecting the metal grid with the frame. In this manner a quick, safe and efficient installation of the screen panel is realized. The same applies for removing the screen panel.

The metal grid is provided with a first set of preferably parallel extending and preferably evenly spaced bars and a second set of preferably parallel extending and preferably evenly spaced bars, wherein the bars of the first set include an angle with the bars of the second set. The bars of the first set are preferably woven with the bars of the second set. Preferably, the metal grid is made of austenite. The diameter of the bars is preferably as small as possible, such that the incoming air flow encounters a minimum resistance. On the other hand the diameter of the bars needs to have a minimum dimension to provide sufficient rigidity and/or strength to the grid. By embedding at least a circumferential part of the edge of the metal grid in an elastic layer the rigidity of the complete metal grid is increased, in particular if the metal grid is clamped into the frame. Due to this increased rigidity it is possible that the diameter of the bars is further reduced compared to metal grids having no edges embedded in elastic layer(s). These bars having a reduced diameter provide less resistance to the incoming air flow, i.e. provide less turbulence, which increases the efficiency of the filters in the air inlet house and the efficiency of the combustion turbine.

In this specification, if the circumferential edge of the grid or a part thereof is embedded in the elastic layer, it is meant that the outermost edge of the grid seen from the centre of the grid, is covered with the elastic layer, i.e. does not protrude in an outward direction (seen from the centre of the grid) with regard to the elastic layer.

By using an elastic layer, preferably a strip-like elastic layer, for the grid, it is possible to clamp this strip-like elastic layer of the grid firmly in the frame in such a manner that the grid in use of the combustion engine, is substantially vibration free connected to the frame. This reduces noise, but more important reduces wear of the grid increasing the overall durability of the screen panel.

Preferably, the entire circumferential edge of the metal grid is embedded with the elastic layer. In this manner all advantages mentioned above are applicable and as the elastic layer(s) including the entire circumferential edge of the metal grid is (are) clamped into the frame, the metal grid is even better connected thereto.

In a further aspect of the screen panel according to the present invention, the width of the elastic layer is provided by the distance between two opposing and substantially parallel extending edges of the elastic layer, wherein the width of the elastic layer is maximally 1/10 of the shortest distance between centre of the grid and the circumferential edge of the grid.

The elastic layer is preferably strip-shaped, wherein the strip-shaped elastic layer comprises two opposing longitudinal and parallel extending edges, wherein the distance between these edges corresponds to the width of the elastic layer. On the one hand the width is preferably as short as possible, as no air is able to pass through the elastic layer, on the other hand a certain width depending on the dimensions of the grid needs to be present as otherwise the rigidity of the grid is not increased and/or the grid can not be firmly enough clamped into the frame. It is possible that only parts of an edge are embedded in spaced apart elastic layer parts. For example it is possible that one circumferential edge of a rectangular shaped metal grid, comprises several spaced apart elastic layer parts. For increasing rigidity to the grid it is advantageous as the complete edge of a rectangular shaped metal grid is embedded in one strip-like elastic layer.

The elastic layer is made from plastic, preferably PVC. By making the elastic layer from plastic the metal grid is galvanic isolated from the frame, as the metal grid is connected to the frame only by means of the plastic elastic layer. In this way if the frame is made of metal, additional galvanic isolators may be omitted.

Although the screen panel may have any shape such as for example circular, the most preferred shape used for screen panels is rectangular. A rectangular shape of the screen panel, including a square shaped screen panel, is convenient for transport and easy to handle during installation of the panel screen.

The frame of the screen panel according to the present invention comprises a U-profile and/or a H-profile, wherein the distance between ends of two opposing legs of the U-profile or the H-profile substantially corresponds with the thickness of the elastic layer. Preferably, the frame is made from a flexible material such that the elastic layer can be placed between flexible spreading legs of the U-profile or the H-profile for clamping the elastic layer between these legs. The frame can be connected to the edges of an air intake opening directly for example by screws or by means of a sub-frame.

For a rectangular screen panel only two opposing circumferential edges of the metal grid need to be embedded, partly or substantially complete, in elastic layers for securing the metal grid to the frame by clamping force, wherein two opposing frame parts of the frame for clamping the elastic layers of the metal grid are made preferably from aluminium. Aluminium is remarkable for its flexibility and for its ability to resist corrosion. If all circumferential edges of the rectangular metal grid are provided with an elastic layer, it may be cost-effective that the other two opposing frame parts of the frame for clamping the elastic layer are made from plastic.

The invention will now be explained in more detail with reference to an exemplary embodiment shown in the appended figures, in which:

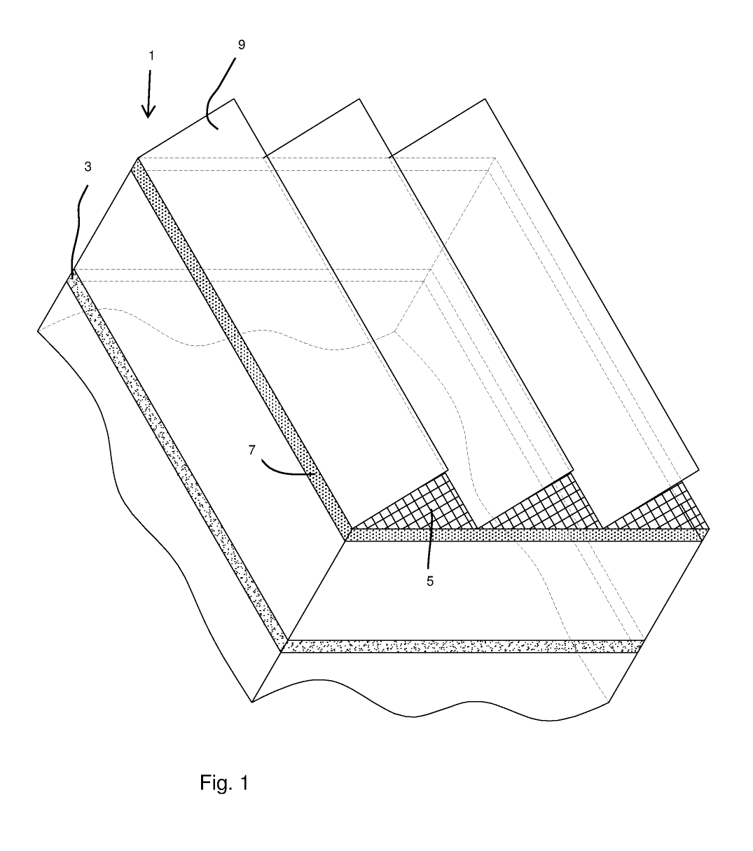

FIG. 1 shows a perspective view of a part of an air inlet house of a combustion turbine,

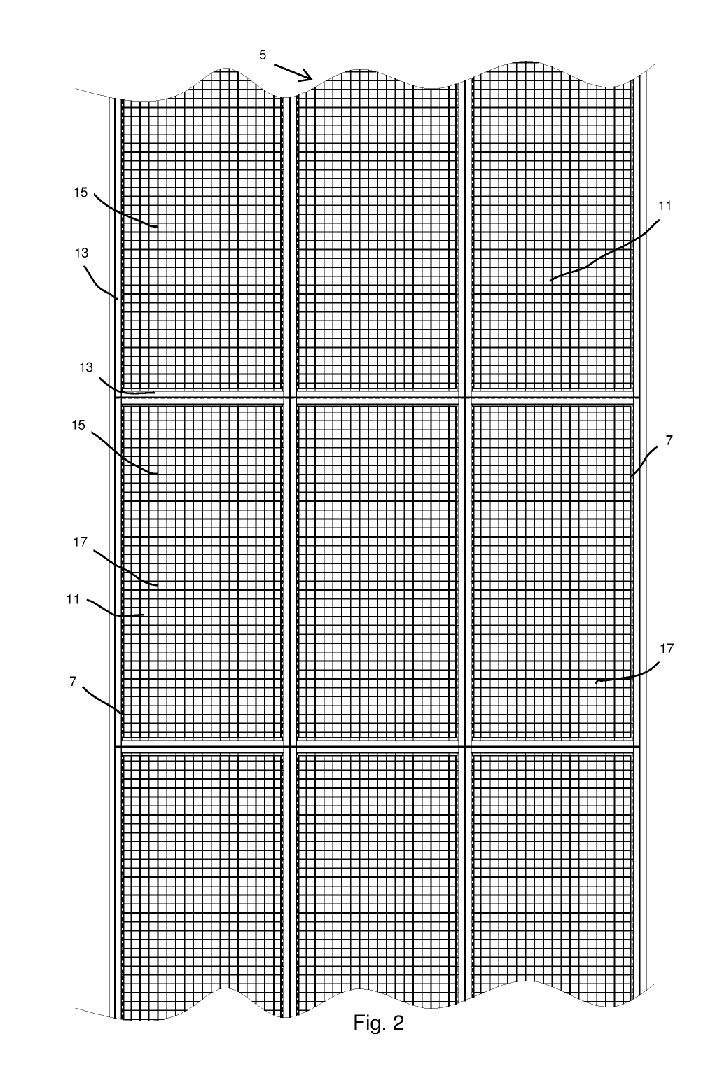

FIG. 2 shows a front view of a number of screen panels according to the present invention covering an air intake opening of the air inlet house shown in FIG. 1,

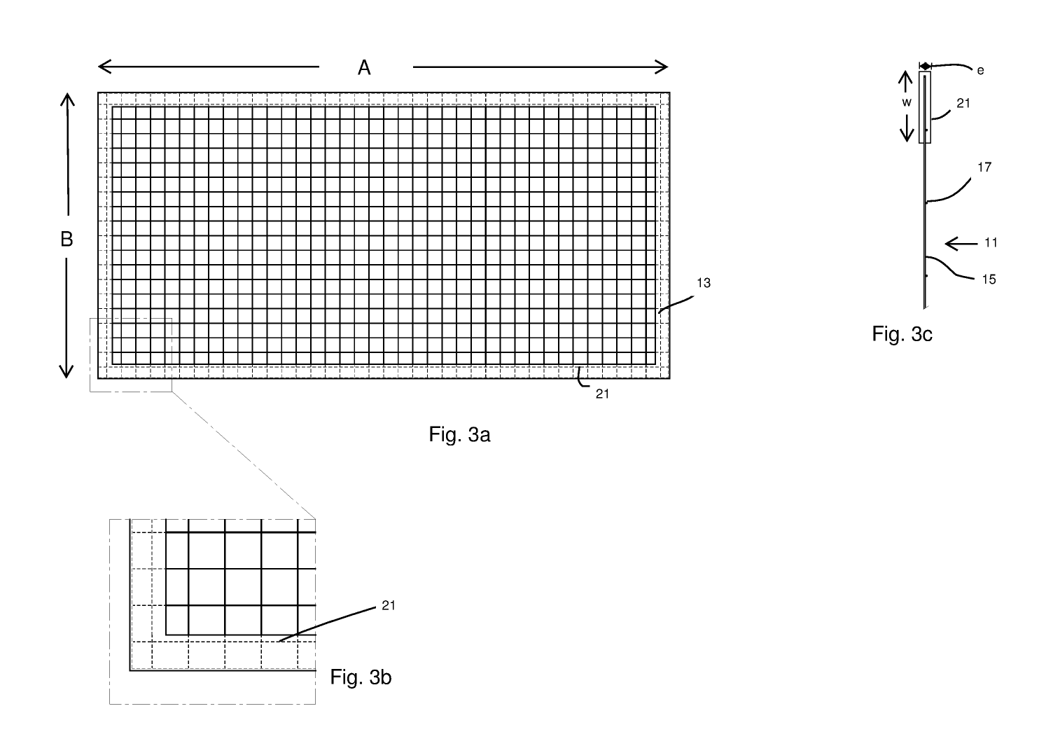

FIGS. 3a, 3b 3c show different views of a grid of a screen panel according to the invention.

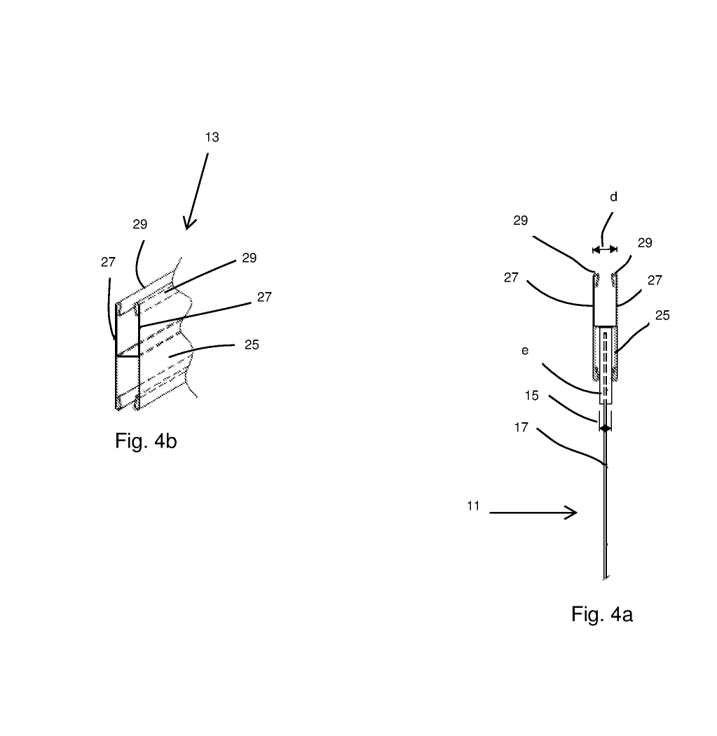

FIGS. 4a and 4b show a section of part of a screen panel according to the invention, respectively a part of a frame of a screen panel according to the invention.

Like parts are indicated by the same numerals in the various figures. FIG. 1 shows an air inlet house 1 of an combustion engine (not shown) comprising filters 3, of which only one has been shown in FIG. 1. Atmospheric air is sucked into the air inlet house through a relatively large air intake opening 5, which has been covered entirely by a number of rectangular screen panels 7. The air inlet house 1 further comprises plates 9 forming an acute angle with the plane defined by the screen panels 7. By means of these plates 9 air is fed into the air inlet house 1 in a preferred direction.

FIG. 2 shows a front view without the plates 9 of the screen panels 7 covering the relatively large air intake opening 5 of the inlet house 1. Each screen panel 7 comprises a metal grid 11, and a frame 13 connected to the edges (not visible) of the air intake opening 5.

The metal grid 11 is provided with a first set of parallel vertical extending and evenly spaced bars 15 and a second set of horizontal parallel extending and evenly spaced bars 17. The bars of the first set are preferably woven with the bars of the second set. Preferably, the metal grid is made of austenite.

As shown in FIGS. 2, 3a-c and 4a, 4b at least a part of a circumferential edge of the metal grid 11 is embedded in an elastic layer 21 (in FIGS. 2, 3a and 3b the elastic layer is partly indicated with a dotted line as the frame 13 is covering the elastic layer and the circumferential edge of the metal grid 11). FIG. 3c shows a section of the metal grid 11 comprising vertical 15 and horizontal extending bars 15, 17, wherein the circumferential edge of the metal grid 11 is embedded in an elastic layer 21. The frame 13, as shown in detail in FIGS. 4a, 4b, is an H-profile 25, wherein the smallest distance d between ends of two opposing legs 27 of the H-profile 25 substantially corresponds with the thickness e of the elastic layer 21. The ends 29 of the legs 27 are folded. The elastic layer 21 can easily be placed between the ends 29 and the flexible spreading legs 27 of the H-profile 25 for clamping the elastic layer 21 between these legs 27 and securing the metal grid 11 to the frame 13. Preferably, the frame is made from aluminium. It is also possible to make the frame from plastic.

The circumferential edge of the metal grid 11 and the elastic layer 21 are integrated with each other, i.e. are one-piece connected with each other. No parts of the circumferential edge of the metal grid 11 protrude from the elastic layer 21 in an outward direction seen from the centre of the metal grid 11. The elastic layer is made from plastic, preferably PVC or PU.

In the exemplary embodiment shown in the drawings the entire circumferential edge of the metal grid 11 is enclosed with the elastic layer 21, such that the complete edge of the metal grid is formed by the elastic layer. It is also possible that only parts (not shown) of the circumferential edge of the metal grid 11 are provided with the elastic layer 21 for clamping the metal grid 11 to the frame 13. The elastic layer may comprise several spaced apart elastic layer parts (not shown) positioned on one circumferential edge of the grid. Further, it is possible that a circumferential edge of the grid is not completely embedded (not shown) in an elastic strip-like layer, but only partly, for example for only 50% or more.

The distance A between two vertical opposing edges of the metal grid 11 is about 1 meter, wherein the distance B between two horizontal opposing edges of the metal grid 11 is about 0.5 meter. The screen panel 7 is used as a bird screen panel, wherein the mesh width of the metal gird 11 is approximately 25 millimetres. It is also possible to use instead of a bird screen panel or in addition, an insect screen panel (not shown), wherein the metal grid of the insect screen panel has a maximum mesh width of 5 millimetres.

The thickness e of the elastic layer 21 is approximately 10 mm, whereas the width w of the elastic layer 21 should be preferably corresponding to at least one mesh width. In the exemplary embodiment shown in the figures the width w of the elastic layer 21 is approximately 50 mm.

1. A screen panel for at least partly covering an air intake opening of an air inlet house of a combustion engine or a compressor, which air inlet house has at least one filter for filtering the air to be supplied to the combustion engine or the compressor, wherein the screen panel comprises:
at least a frame to be connected to the air inlet house,
at least a metal grid to be connected with the frame for at least partly covering the air intake opening of the air inlet house, characterized in that, at least a part of a circumferential edge of the metal grid is embedded in an elastic layer, wherein the elastic layer can be clamped into the frame for connecting the metal grid with the frame.

2. A screen panel according to claim 1, wherein the entire circumferential edge of the metal grid is embedded with the elastic layer.

3. A screen panel according to claim 1, wherein the width of the elastic layer is provided by the distance between two opposing and substantially parallel extending edges of the elastic layer, wherein the width of the elastic layer is maximally 1/10 of the shortest distance between the center of the grid and the circumferential edge of the grid.

4. A screen panel according to claim 1, wherein the screen panel has a rectangular shape, wherein at least two opposing circumferential edges of the metal grid are at least partly embedded in elastic layers.

5. A screen panel according to claim 1, wherein the frame comprises a U-profile, wherein the elastic layer can be clamped between two opposing flexible legs of the U-profile.

6. A screen panel according to claim 1, wherein the at least one circumferential edge is partly embedded by several spaced apart elastic layer parts.

7. A screen panel according to claim 1, wherein the at least one circumferential edge is at least partly embedded in one strip-like elastic layer.

8. A screen panel according to claim 1, wherein the elastic layer is plastic.

9. A screen panel according to claim 1, wherein the minimum distance between two opposing circumferential edges of the grid is 40 centimeters.

10. A screen panel according to claim 1, wherein the screen panel is a bird screen panel, wherein the metal grid of the bird screen panel has a minimum mesh width of 20 millimeters.

11. A screen panel according to claim 1, wherein the screen panel is an insect screen panel, wherein the metal grid of the insect screen panel has a maximum mesh width of 5 millimeters.

12. An air inlet house of a combustion engine having at least one air intake opening comprising a screen panel according to claim 1.

13. A screen panel according to claim 1, wherein the frame comprises a H-profile, wherein the elastic layer can be clamped between two opposing flexible legs of the H-profile.

14. A screen panel according to claim 8, wherein the plastic is polyvinyl chloride (PVC).

15. A screen panel according to claim 8, wherein the plastic is polyurethane (PU).

16. An air inlet house of a compressor having at least one air intake opening comprising a screen panel according to claim 1.
